(19) United States
(12) Patent Application Publication
(10) Pub. No.: US 2019/0108795 A1
(43) Pub. Date: Apr. 11, 2019

(54) ELECTRO-OPTIC DISPLAYS, AND METHODS FOR DRIVING SAME

(71) Applicant: E INK CORPORATION, Billerica, MA (US)

(72) Inventors: Dan John LAUBER, Somerville, MA (US); David Darrell MILLER, Wakefield, MA (US); Wenjie LAN, San Diego, CA (US); Yi LU, Needham, MA (US)

(21) Appl. No.: 16/043,206

(22) Filed: Jul. 24, 2018

Related U.S. Application Data
(60) Provisional application No. 62/536,301, filed on Jul. 24, 2017.

(51) Int. Cl. G09G 3/34

(52) U.S. Cl. CPC G09G 3/344; G09G 2310/06; G09G 2320/0204; G09G 2320/043

(57) ABSTRACT

A method for driving a display having at least one display pixel is provided, the method may include applying a waveform to the at least one display pixel, maintaining a floating state on the display pixel, and shorting the display pixel.

### REFERENCE TO RELATED APPLICATIONS

This application is related to and claims priority of U.S. Provisional Application 62/536,301 filed on Jul. 24, 2017. The entire disclosure of the aforementioned application is herein incorporated by reference.

### SUBJECT OF THE INVENTION

This invention relates to reflective electro-optic displays and materials for use in such displays. More specifically, this invention relates to displays with reduced remnant voltage and driving methods for reducing remnant voltage in electro-optic displays.

### BACKGROUND

Electro-optics displays driven by direct current (DC) imbalanced waveforms may produce a remnant voltage, this remnant voltage being ascertainable by measuring the open-circuit electrochemical potential of a display pixel. It has been found that remnant voltage is a more general phenomenon in electrophoretic and other impulse-driven electro-optic displays, both in cause(s) and effect(s). It has also been found that DC imbalances may cause long-term lifetime degradation of some electrophoretic displays.

The term “remnant voltage” is also sometimes used as a term of convenience referring to an overall phenomenon. However, the basis for the switching behavior of impulse-driven electro-optic displays is the application of a voltage impulse (the integral of voltage with respect to time) across the electro-optic medium. Remnant voltage may reach a peak value immediately after the application of a driving pulse, and thereafter may decay substantially exponentially. The persistence of the remnant voltage for a significant time period applies a “remnant impulse” to the electro-optic medium, and strictly speaking this remnant impulse, rather than the remnant voltage, may be responsible for the effects on the optical states of electro-optic displays normally considered as caused by remnant voltage.

In theory, the effect of remnant voltage should correspond directly to remnant impulse. In practice, however, the impulse switching model can lose accuracy at low voltages. Some electro-optic media have a threshold, such that a remnant voltage of about 1 V may not cause a noticeable change in the optical state of the medium after a drive pulse ends. However, other electro-optic media, including preferred electrophoretic media used in experiments described herein, a remnant voltage of about 0.5 V may cause a noticeable change in the optical state. Thus, two equivalent remnant impulses may differ in actual consequences, and it may be helpful to increase the threshold of the electro-optic medium to reduce the effect of remnant voltage. E Ink Corporation has produced electrophoretic media having a “small threshold” adequate to prevent remnant voltage experienced in some circumstances from immediately changing the display image after a drive pulse ends. If the threshold is inadequate or if the remnant voltage is too high, the display may present a kickback/self-erasing or self-improving phenomenon. Where the term “optical kickback” is used herein to describe a change in a pixel's optical state which occurs at least partially a response to the discharge of the pixel's remnant voltage.

Even when remnant voltages are below a small threshold, they may have a serious effect on image switching if they still persist when the next image update occurs. For example, suppose that during an image update of an electrophoretic display a +/−15 V drive voltage is applied to move the electrophoretic particles. If a +1 V remnant voltage persists from a prior update, the drive voltage would effectively be shifted from +15 V/−15 V to +16 V/−14 V. As a result, the pixel would be biased toward the dark or white state, depending on whether it has a positive or negative remnant voltage. Furthermore, this effect varies with elapsed time due to the decay rate of the remnant voltage. The electro-optic material in a pixel switched to white using a 15 V, 300 ms drive pulse immediately after a previous image update may actually experience a waveform closer to 16 V for 300 ms, whereas the material in a pixel switched to white one minute later using the exact same drive pulse (15 V, 300 ms) may actually experience a waveform closer to 15.2 V for 300 ms. Consequently the pixels may show noticeably different shades of white.

If the remnant voltage field has been created across multiple pixels by a prior image (say a dark line on a white background) then the remnant voltages may also be arrayed across the display in a similar pattern. In practical terms then, the most noticeable effect of remnant voltage on display performance may be ghosting. This problem is in addition to the problem previously noted, namely that DC imbalance (e.g. 16 V/14 V instead of 15 V/15 V) may be a cause of slow lifetime degradation of the electro-optic medium.

If a remnant voltage decays slowly and is nearly constant, then its effect in shifting the waveform does not vary from image update to update and may actually create less ghosting than a remnant voltage that decays quickly. Thus the ghosting experienced by updating one pixel after 10 minutes and another pixel after 11 minutes is much less than the ghosting experienced by updating one pixel immediately and another pixel after 1 minute. Conversely, a remnant voltage that decays so quickly that it approaches zero before the next update occurs may in practice cause no detectable ghosting.

There are multiple potential sources of remnant voltage. It is believed (although some embodiments are in no way limited by this belief), that one large cause of remnant voltage is ionic polarization within the materials of the various layers forming the display.

To summarize, remnant voltage as a phenomenon can present itself as image ghosting or visual artifacts in a variety of ways, with a degree of severity that can vary with the elapsed times between image updates. Remnant voltage can also create a DC imbalance and reduce ultimate display lifetime. The effects of remnant voltage therefore may be deleterious to the quality of the electrophoretic or other electro-optic device and it is desirable to minimize both the remnant voltage itself, and the sensitivity of the optical states of the device to the influence of the remnant voltage.

Thus, discharging a remnant voltage of an electro-optic display may improve the quality of the displayed image, even in circumstances where the remnant voltage is already low. The inventors have recognized and appreciated that conventional techniques for discharging a remnant voltage of an electro-optic display may not fully discharge the remnant voltage. That is, conventional techniques of discharging the remnant voltage may result in the electro-optic display retaining at least a low remnant voltage. Thus, techniques for more fully discharging remnant voltages from electro-optic displays are needed.

### SUMMARY OF INVENTION

The subject matter presented herein provides a method for driving a display pixel having at least one display pixel. The method may include applying a waveform to the at least one display pixel, maintaining a floating state on the display pixel, and shorting the display pixel.

### BRIEF DESCRIPTION OF DRAWINGS

FIG. 1 is a circuit diagram representing an electrophoretic display;

FIG. 2 shows a circuit model of the electro-optic imaging layer;

FIG. 3 illustrates a block diagram of an exemplary float-then-shot (FTS) waveform;

FIG. 4 illustrates a timing diagram of an exemplary FTS waveform;

FIG. 5 illustrates display performances using the FTS method;

FIG. 6 illustrates an exemplary implementation for the FTS method presented herein; and

FIG. 7 illustrates another implementation of the FTS method presented herein.

### DETAILED DESCRIPTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example, the aforementioned white and dark blue states. The term “monochrome” may be used hereinafter to denote a drive scheme which only drives pixels to their two extreme optical states with no intervening gray states.

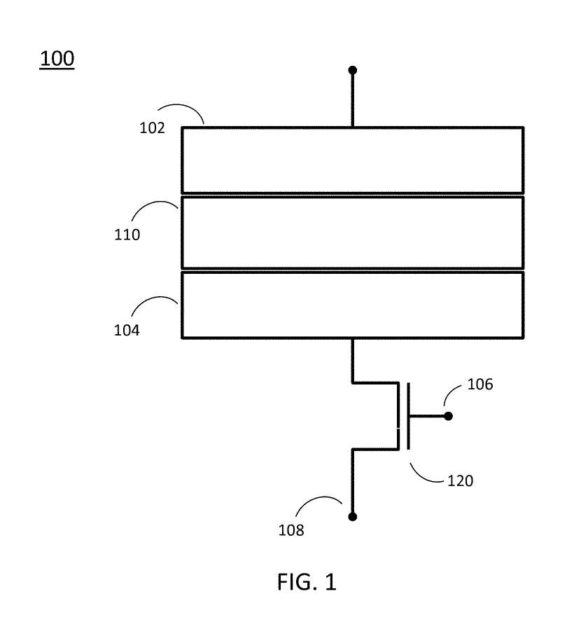

Much of the discussion below will focus on methods for driving one or more pixels of an electro-optic display through a transition from an initial gray level to a final gray level (which may or may not be different from the initial gray level). The term “waveform” will be used to denote the entire voltage against time curve used to effect the transition from one specific initial gray level to a specific final gray level. Typically such a waveform will comprise a plurality of waveform elements; where these elements are essentially rectangular (i.e., where a given element comprises application of a constant voltage for a period of time); the elements may be called “pulses” or “drive pulses”. The term “drive scheme” denotes a set of waveforms sufficient to effect all possible transitions between gray levels for a specific display. In some embodiments, a waveform or a driving waveform may include a plurality of driving pulses configured to drive a display pixel to a desired optical state. Where in between the plurality of driving pulses the display pixel may be kept in a floating state. In some embodiments, when the display is in this floating state, the display pixel's transistor (e.g., see element 120 below in FIG. 1) may be in a non-conductive state, for example, the gate voltage to of the pixel's transistor may be low.

In practice, a display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, as described in several of the aforementioned MEDEOD applications, to use more than one drive scheme simultaneously in different areas of the same display, and a set of drive schemes used in this manner may be referred to as “a set of simultaneous drive schemes.”

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:

(a) Electrophoretic particles, fluids and fluid additives; see for example U.S. Pat. Nos. 7,002,728 and 7,679,814;

(b) Capsules, binders and encapsulation processes; see for example U.S. Pat. Nos. 6,922,276 and 7,411,719;

(c) Microcell structures, wall materials, and methods of forming microcells; see for example U.S. Pat. Nos. 7,072,095 and 9,279,906;

(d) Methods for filling and sealing microcells; see for example U.S. Pat. Nos. 7,144,942 and 7,715,088;

(e) Films and sub-assemblies containing electro-optic materials; see for example U.S. Pat. Nos. 6,982,178 and 7,839,564;

(f) Backplanes, adhesive layers and other auxiliary layers and methods used in displays; see for example U.S. Pat. Nos. 7,116,318 and 7,535,624;

(g) Color formation and color adjustment; see for example U.S. Pat. Nos. 7,075,502 and 7,839,564.

(h) Applications of displays; see for example U.S. Pat. Nos. 7,312,784; 8,009,348;

(i) Non-electrophoretic displays, as described in U.S. Pat. No. 6,241,921 and U.S. Patent Application Publication No. 2015/0277160; and applications of encapsulation and microcell technology other than displays; see for example U.S. Patent Application Publications Nos. 2015/0005720 and 2016/0012710; and

Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0070032; 2007/0076289; 2007/0091418; 2007/0103427; 2007/0176912; 2007/0296452; 2008/0024429; 2008/0024482; 2008/0136774; 2008/0169821; 2008/0218471; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2016/0071465; 2016/0078820; 2016/0093253; 2016/0140910; and 2016/0180777.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display.” In a microcell electrophoretic display, the charged particles and the suspending fluid are not encapsulated within microcapsules but instead are retained within a plurality of cavities formed within a carrier medium, e.g., a polymeric film. See, for example, International Application Publication No. WO 02/01281, and published U.S. Application No. 2002/0075556, both assigned to Sipix Imaging, Inc.

Many of the aforementioned E Ink and MIT patents and applications also contemplate microcell electrophoretic displays and polymer-dispersed electrophoretic displays. The term “encapsulated electrophoretic displays” can refer to all such display types, which may also be described collectively as “microcavity electrophoretic displays” to generalize across the morphology of the walls.

Another type of electro-optic display is an electro-wetting display developed by Philips and described in Hayes, R. A., et al., “Video-Speed Electronic Paper Based on Electrowetting,” Nature, 425, 383-385 (2003). It is shown in copending application Ser. No. 10/711,802, filed Oct. 6, 2004, that such electro-wetting displays can be made bistable.

Other types of electro-optic materials may also be used. Of particular interest, bistable ferroelectric liquid crystal displays (FLCs) are known in the art and have exhibited remnant voltage behavior.

Although electrophoretic media may be opaque (since, for example, in many electrophoretic media, the particles substantially block transmission of visible light through the display) and operate in a reflective mode, some electrophoretic displays can be made to operate in a so-called “shutter mode” in which one display state is substantially opaque and one is light-transmissive. See, for example, the patents U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

A high-resolution display may include individual pixels which are addressable without interference from adjacent pixels. One way to obtain such pixels is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. When the non-linear element is a transistor, the pixel electrode may be connected to the drain of the transistor, and this arrangement will be assumed in the following description, although it is essentially arbitrary and the pixel electrode could be connected to the source of the transistor. In high-resolution arrays, the pixels may be arranged in a two-dimensional array of rows and columns, such that any specific pixel is uniquely defined by the intersection of one specified row and one specified column. The sources of all the transistors in each column may be connected to a single column electrode, while the gates of all the transistors in each row may be connected to a single row electrode; again the assignment of sources to rows and gates to columns may be reversed if desired.

The display may be written in a row-by-row manner. The row electrodes are connected to a row driver, which may apply to a selected row electrode a voltage such as to ensure that all the transistors in the selected row are conductive, while applying to all other rows a voltage such as to ensure that all the transistors in these non-selected rows remain non-conductive. The column electrodes are connected to column drivers, which place upon the various column electrodes voltages selected to drive the pixels in a selected row to their desired optical states. (The aforementioned voltages are relative to a common front electrode which may be provided on the opposed side of the electro-optic medium from the non-linear array and extends across the whole display. As in known in the art, voltage is relative and a measure of a charge differential between two points. One voltage value is relative to another voltage value. For example, zero voltage (“0V”) refers to having no voltage differential relative to another voltage.) After a pre-selected interval known as the “line address time,” a selected row is deselected, another row is selected, and the voltages on the column drivers are changed so that the next line of the display is written.

However, in use, certain waveforms may produce a remnant voltage to pixels of an electro-optic display, and as evident from the discussion above, this remnant voltage produces several unwanted optical effects and is in general undesirable.

As presented herein, a “shift” in the optical state associated with an addressing pulse refers to a situation in which a first application of a particular addressing pulse to an electro-optic display results in a first optical state (e.g., a first gray tone), and a subsequent application of the same addressing pulse to the electro-optic display results in a second optical state (e.g., a second gray tone). Remnant voltages may give rise to shifts in the optical state because the voltage applied to a pixel of the electro-optic display during application of an addressing pulse includes the sum of the remnant voltage and the voltage of the addressing pulse.

A “drift” in the optical state of a display over time refers to a situation in which the optical state of an electro-optic display changes while the display is at rest (e.g., during a period in which an addressing pulse is not applied to the display). Remnant voltages may give rise to drifts in the optical state because the optical state of a pixel may depend on the pixel's remnant voltage, and a pixel's remnant voltage may decay over time.

As discussed above, “ghosting” refers to a situation in which, after the electro-optic display has been rewritten, traces of the previous image(s) are still visible. Remnant voltages may give rise to “edge ghosting,” a type of ghosting in which an outline (edge) of a portion of a previous image remains visible.

Where the term “optical kickback” is used herein to describe a change in a pixel's optical state that occurred at least partially due to the discharge of the pixel's remnant voltage.

FIG. 1 shows a schematic of a pixel 100 of an electro-optic display in accordance with the subject matter submitted herein. Pixel 100 may include an imaging film 110. In some embodiments, imaging film 110 may be bistable. In some embodiments, imaging film 110 may include, without limitation, an encapsulated electrophoretic imaging film, which may include, for example, charged pigment particles.

Imaging film 110 may be disposed between a front electrode 102 and a rear electrode 104. Front electrode 102 may be formed between the imaging film and the front of the display. In some embodiments, front electrode 102 may be transparent and may be formed of any suitable transparent material, including, without limitation, indium tin oxide (ITO). Rear electrode 104 may be formed opposite a front electrode 102. In some embodiments, a parasitic capacitance (not shown) may be formed between front electrode 102 and rear electrode 104.

Pixel 100 may be one of a plurality of pixels. The plurality of pixels may be arranged in a two-dimensional array of rows and columns to form a matrix, such that any specific pixel is uniquely defined and/or driven by the intersection of one specified row and one specified column. In some embodiments, the matrix of pixels may be an “active matrix,” in which each pixel is associated with at least one non-linear circuit element 120. The non-linear circuit element 120 may be coupled between back-plate electrode 104 and an addressing electrode 108. In some embodiments, non-linear element 120 may include a diode and/or a transistor, including, without limitation, a MOSFET. The drain (or source) of the MOSFET may be coupled to back-plate electrode 104, the source (or drain) of the MOSFET may be coupled to addressing electrode 108, and the gate of the MOSFET may be coupled to a driver electrode 106 configured to control the activation and deactivation of the MOSFET. (For simplicity, the terminal of the MOSFET coupled to back-plate electrode 104 will be referred to as the MOSFET's drain, and the terminal of the MOSFET coupled to addressing electrode 108 will be referred to as the MOSFET's source. However, one of ordinary skill in the art will recognize that, in some embodiments, the source and drain of the MOSFET may be interchanged.)

In some embodiments of the active matrix, the addressing electrodes 108 of all the pixels in each column may be connected to a same column electrode, and the driver electrodes 106 of all the pixels in each row may be connected to a same row electrode. The row electrodes may be connected to a row driver, which may select one or more rows of pixels by applying to the selected row electrodes a voltage sufficient to activate the non-linear elements 120 of all the pixels 100 in the selected row(s). The column electrodes may be connected to column drivers, which may place upon the addressing electrode 106 of a selected (activated) pixel a voltage suitable for driving the pixel into a desired optical state. The voltage applied to an addressing electrode 108 may be relative to the voltage applied to the pixel's front-plate electrode 102 (e.g., a voltage of approximately zero volts). In some embodiments, the front-plate electrodes 102 of all the pixels in the active matrix may be coupled to a common electrode.

In some embodiments, the pixels 100 of the active matrix may be written in a row-by-row manner. For example, a row of pixels may be selected by the row driver, and the voltages corresponding to the desired optical states for the row of pixels may be applied to the pixels by the column drivers. After a pre-selected interval known as the “line address time,” the selected row may be deselected, another row may be selected, and the voltages on the column drivers may be changed so that another line of the display is written.

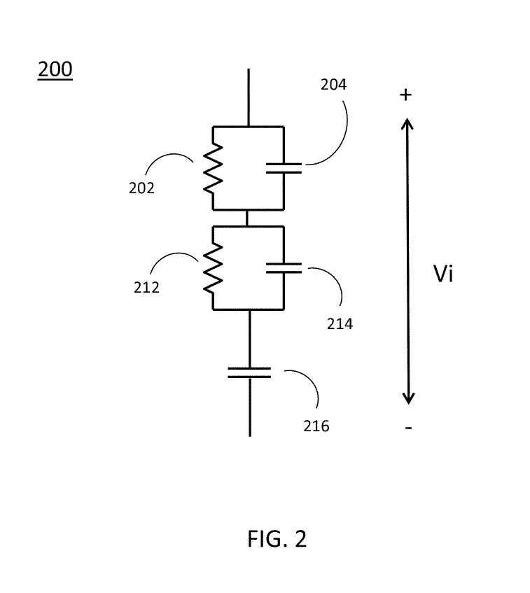

FIG. 2 shows a circuit model of the electro-optic imaging layer 110 disposed between the front electrode 102 and the rear electrode 104 in accordance with the subject matter presented herein. Resistor 202 and capacitor 204 may represent the resistance and capacitance of the electro-optic imaging layer 110, the front electrode 102 and the rear electrode 104, including any adhesive layers. Resistor 212 and capacitor 214 may represent the resistance and capacitance of a lamination adhesive layer. Capacitor 216 may represent a capacitance that may form between the front electrode 102 and the back electrode 104, for example, interfacial contact areas between layers, such as the interface between the imaging layer and the lamination adhesive layer and/or between the lamination adhesive layer and the backplane electrode. A voltage Vi across a pixel's imaging film 110 may include the pixel's remnant voltage.

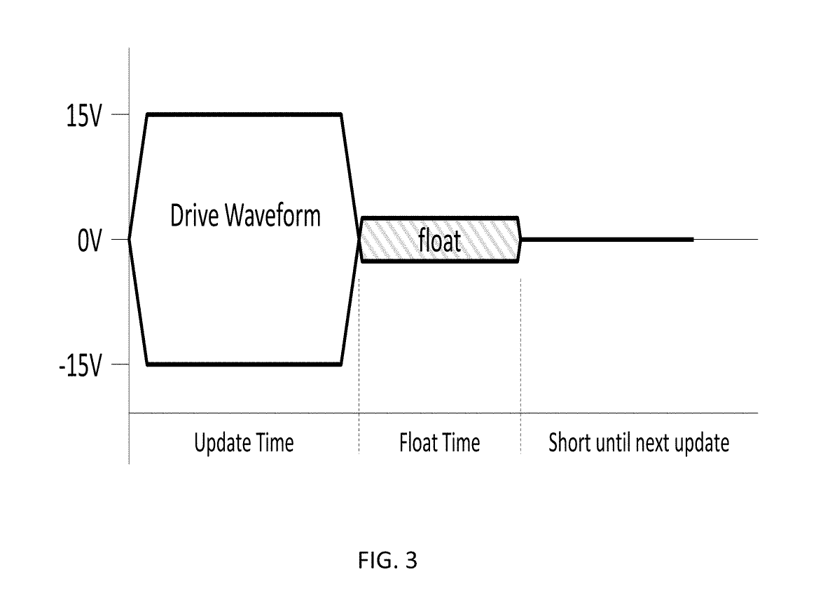

The discharge of the remnant voltage of a pixel may be initiated and/or controlled by applying any suitable set of signals to a pixel, including, without limitation, a set of signals as illustrated in more details below in FIG. 3.

FIG. 3 illustrates one exemplary embodiment of a set of signals for reducing remnant voltages in accordance with the subject matter presented herein. After one or more drive waveforms or signals (i.e., one or more positive and/or negative voltage pulses) have been applied to a display pixel, the pixel may be put in a floating state (i.e., a state where the pixel is substantially isolated or as if it is not connected to any conductive path) for a period of time (e.g., 1-10 seconds), and subsequently the pixel may be substantially shorted until the next update time. In practice, when the display pixel is in this floating state, the leakage current from the display is very low such that it can be ignored as if an open connection exists between the display pixel and any conductive paths. For example, the non-linear element 120 coupled to the display pixel as shown in FIG. 1, which may be a transistor, could be in an off or non-conductive state, and can effectively function as an open circuit to the display pixel, putting the display pixel in a floating state. In some other embodiments, a high impedance element or circuit may be used to function substantially as an open circuit (e.g., but lowering the leakage current) and isolate the display pixel from any conductive paths, putting the display pixel in a floating state.

Referring back to the float-then-short (FTS) pattern illustrated in FIG. 3, in general, this working principle covers any number of short and float segments so long a driving waveform has more than one of each segment.

In some embodiments, a comparatively long short duration in a thin-film transistor (TFT) may be implemented, for example, by waking the display during an inter-update period after a period of floating and driving a number of zero volt frames to the display. The display may subsequently return to a floating state, or may alternate between floating and 0V drive any number of times before the next update. In this fashion, during the inter-update period, a display may experience a period of low external discharge (i.e., high impedance or floating), followed by high external discharges (i.e., low impedance, shorting, or zero volt driving).

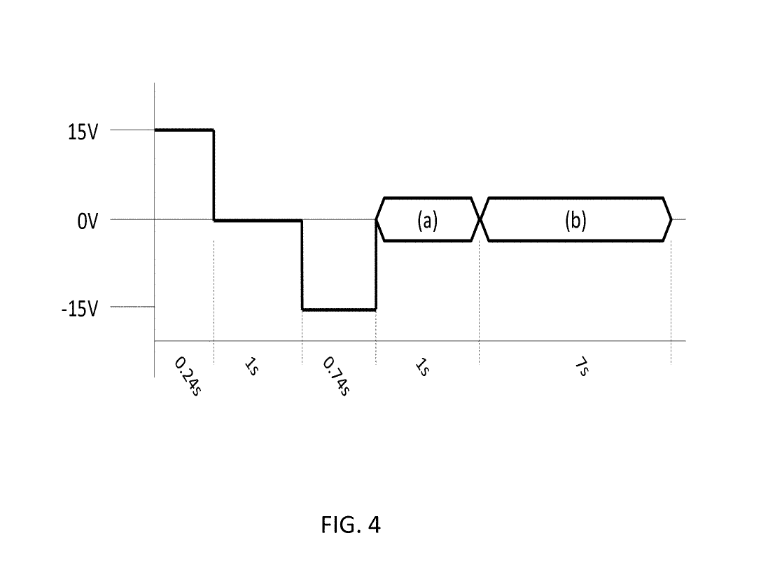

In one example, a glass of sample ink (e.g., EInk™ V220 ink) was operated with an imbalanced waveform of: 0.24 second at 15V, 1 second at 0V, and then 0.74 second at −15V, as illustrated in FIG. 4. As shown in FIG. 4, each update may be subsequently followed by an 8-second inter-update period, divided into a 1 second part (a) and 7 second part (b). Four sample pixels where individual pixel may be driven with a different combination of short or float during inter-update periods (a) and (b), as presented in Table 1 below. This glass of ink was run for 40 days and the remnant voltages and optical states of each sample pixel were measured and are also shown in Table 1. The b* of the back side of the sample is a measurement of permanent damage, where the Float-Then-Short (FTS) pattern showed no evidence of damage, while the float only method, and the short-then-float (STF) and short only methods both showed significant kickback.

TABLE 1

| | | | Remnant | | |
|---|---|---|---|---|---|
| Type | (a) | (b) | Voltage | Front L* | Back b* |
| Float | Float | Float | −1.37 | 67.2 | 9 |
| FTS | Float | Short | −0.44 | 70.8 | −1 |
| STF | Short | Float | −1.15 | 58.2 | 0 |
| Short | Short | Short | −0.39 | 70.6 | −1 |

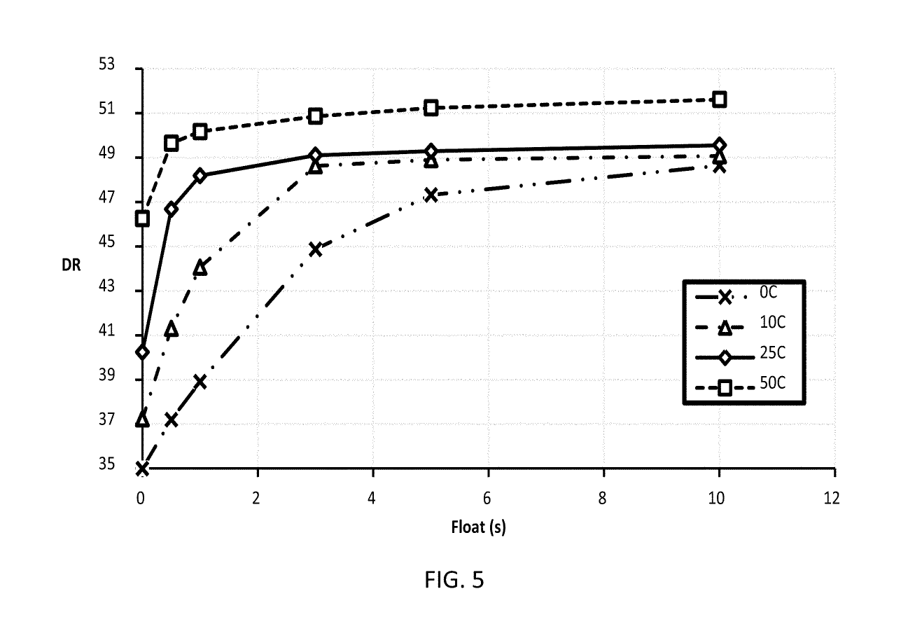

In some embodiments, the efficacy of mitigating short-term optical kickback may be evaluated, and the optimal duration of the floating segment for a specific display may be determined. For example, an EPD sample (e.g., a V230MLT FPL display) on a segmented PCB backplane (e.g., El Dorado) may be driven with 1440 ms+/−15V pulses, then electrically floated for 0, 0.5, 1, 3, 5, or 10 seconds, and then electrically shorted for 30 seconds before the optical brightness was measured in L* units. The difference between the white state and dark state L* is the dynamic range (DR). This was performed with the display at temperatures of 0 C, 10 C, 25 C, and 50 C. The results are shown in FIG. 5, which illustrates that a short float period of sufficient duration can achieve a significant improvement over shorting after the drive pulse, and approaching the performance of indefinite float duration.

Between these two experiments, it can be shown that the FTS method can be effective as shorting at mitigating long-term damage, and at the same time as effective as floating at mitigating short-term kickback.

In summary, floating mitigates short-term kickback after drive segment, shorting mitigates long-term remnant voltage effects. Floating the pixel immediately after the drive segment prevents pigments from kicking back while the short-term remnant voltage decays internally. After the short-term remnant has decayed internally, the pixel may be shorted to discharge long-term remnant voltage without inducing optical kickback.

In practice, the driving methods describe herein may be implemented in various ways. For example, as a display pixel is coupled to a means (e.g., driver or controller) for applying driving waveforms through a conductive path, the impedance value of the conductive may be adjusted in variety of ways to create an open circuit like state for the display pixel, thereby putting the display pixel in a substantially floating state as described above. In some embodiment, means for adjust the impedance value of this conductive path may be a switch, a transistor, an impedance circuit, or an adjustable impedance circuit.

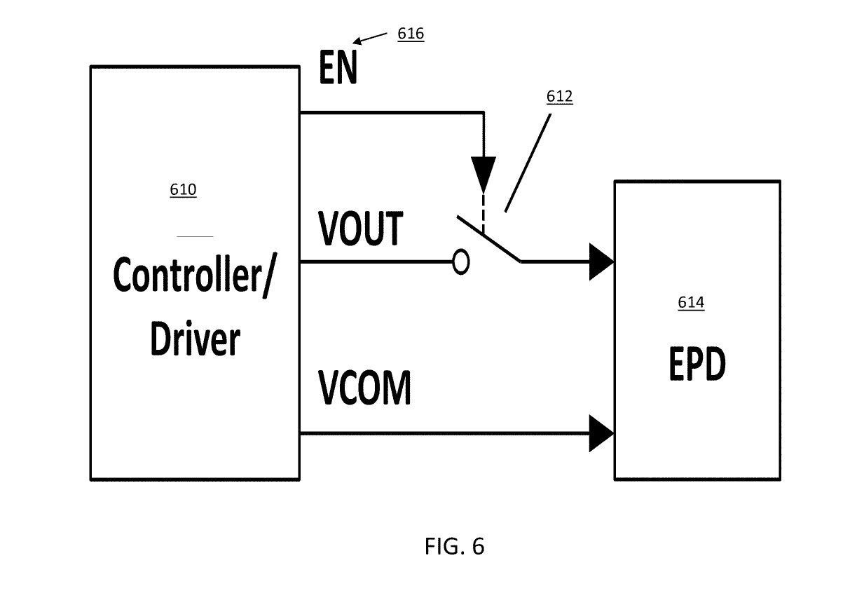

In some embodiments, the subject matter presented herein may be implemented with a system similar to that is illustrated in FIG. 6. Such implementation may be accomplished by, but not limited to, using one or more electronically controlled switch(s), valve(s), or transistor(s) which can disconnect the display top plane and/or back plane from the display drive electronics, switch between two or more resistors in-line with the drive electronics, or connect some resistance or electrical short across the display terminals. Shown in FIG. 6 is a switch 612 connecting a voltage output (VOUT) from a controller or driver 610 to an EPD 614, where the switch may be activated by an enabling signal EN 616. This configuration enables one to place the EPD in a substantially floating state as stated above (e.g., applying the EN signal to open the switch 612, thereby creating an open circuit at VOUT). The switch 612 may be on the VOUT or VCOM, or two switches may be placed on both lines. The switch 612 may in fact be a physical switch such as a reed switch or relay, or may be an equivalent electronic device such as an analog switch. The function of the switch 612 might also be combined with the driver using a high impedance output mode.

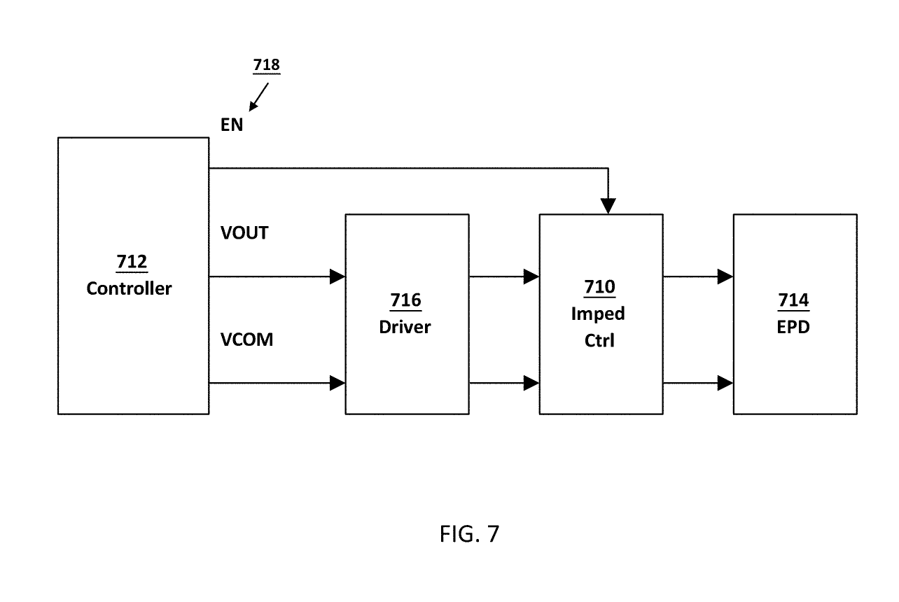

In some other embodiments, any system which modifies the output impedance of the display drive electronics to the display, which also modifies that output impedance during the period between display image updates as illustrated in FIG. 7. As illustrated, an impedance circuit 710 may be controlled by a controller 712 using an enabling signal EN 718. For example, the EN 718 signal may increase the impedance value of the circuit 710 by so much that the circuit 710 functions substantially as an open circuit to the EPD 714, effectively putting the EPD 714 into a floating state as described as above. In practice, driving waveforms or signals generated from a driver 716 will firstly go through the impedance circuit 710 before arriving at the EPD 714.

It will be apparent to those skilled in the art that numerous changes and modifications can be made to the specific embodiments of the invention described above without departing from the scope of the invention. Accordingly, the whole of the foregoing description is to be interpreted in an illustrative and not in a limitative sense.

1. A method for driving a display comprising at least one display pixel, the method comprising:
applying a waveform to the at least one display pixel;
maintaining a floating state on the display pixel; and
shorting the display pixel.

2. The method according to claim 1, wherein the shorting step has a longer time duration than the maintaining a floating state step.

3. The method of claim 1, wherein during the maintaining a floating state step no electrical potential is applied to the at least one display pixel.

4. The method according to claim 1, wherein the net electrical potential between the applying a waveform step, the maintaining a floating state step, and the shorting the display pixel step is substantially DC balanced.

5. The method of claim 1, wherein the maintaining a floating state step has a duration of 1 to 10 seconds.

6. The method of claim 1, wherein the maintaining a floating state step is 0 to 0.5 seconds in duration.

7. The method of claim 1, wherein the maintaining a floating state step is 0 to 1 seconds in duration.

8. The method of claim 1, wherein the maintaining a floating state step is 0 to 3 seconds in duration.

9. The method of claim 1, wherein the maintaining a floating state step is 0 to 5 seconds in duration.

10. The method of claim 1, wherein the shorting step is 0 to 30 seconds in duration.

11. An electro-optic display comprising:
at least one display pixel;
a conductive path coupled to the at least one display pixel for applying driving waveforms to the display pixel; and
means for adjusting the impedance value of the conductive path.

12. The display of claim 11 wherein the means for adjusting the impedance value is a switch.

13. The display of claim 11 wherein the means for adjusting the impedance value is a transistor.

14. The display of claim 11 wherein the means for adjust the impedance value is an impedance circuit.

15. The display of claim 11 wherein the impedance value of the impedance circuit is adjustable.
